(19) United States
(12) Patent Application Publication
(10) Pub. No.: US 2023/0195768 A1
(43) Pub. Date: Jun. 22, 2023

(54) Techniques For Retrieving Document Data

(71) Applicant: TmaxAI Co., Ltd., Gyeonggi-do (KR)

(72) Inventors: Jeonghyun CHOI, Gyeonggi-do (KR); Chunghyeon CHO, Seoul (KR); Sanghak LEE, Gyeonggi-do (KR)

(73) Assignee: TmaxAI Co., Ltd., Gyeonggi-do (KR)

(21) Appl. No.: 17/697,823

(22) Filed: Mar. 17, 2022

(30) Foreign Application Priority Data
Dec. 21, 2021 (KR) 10-2021-0183450

(51) Int. Cl. G06F 16/33; G06F 16/383

(52) U.S. Cl. CPC G06F 16/3347; G06F 16/3334; G06F 16/383

(57) ABSTRACT

According to some exemplary embodiments of the present disclosure, disclosed is a method for retrieving document data, which is performed by a computing device including at least one processor. The method may include: determining a first embedding vector by inputting retrieval word data into a first network model; determining a second embedding vector corresponding to the first embedding vector among a plurality of embedding vectors stored in a storage unit; and providing document data mapped to the second embedding vector.

### CROSS-REFERENCE TO RELATED APPLICATIONS

This application claims priority to and the benefit of Korean Patent Application No. 10-2021-0183450 filed in the Korean Intellectual Property Office on Dec. 21, 2021, the entire contents of which are incorporated herein by reference.

### TECHNICAL FIELD

The present disclosure relates to a method for retrieving document data, and particularly, to a method for retrieving and providing target data having high relevance for at least one a natural language sentence, a subject word, and a keyword which are input.

### BACKGROUND ART

In recent years, due to the rapid development and dissemination of smart devices, data of a document which appears on in the Internet web has been increased every day. With the increase in information, a large quantity of documents are increasing on the Internet Web, and as a result, it is difficult for a user to understand the data of the document. Meanwhile, when a large quantity of documents are retrieved, a retrieval word performing retrieval is input as a natural language, so there is a case where the retrieval is not normally made.

Accordingly, a research into methods for providing target data corresponding to the input retrieval word is actively conducted.

### SUMMARY OF THE INVENTION

The present disclosure is contrived to correspond to the above-described background art, and has been made in an effort to retrieve and provide target data having high relevance for at least one a natural language sentence, a subject word, and a keyword which are input.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for retrieving document data, which is performed by a computing device including at least one processor, including: determining a first embedding vector by inputting retrieval word data into a first network model; determining a second embedding vector corresponding to the first embedding vector among a plurality of embedding vectors stored in a storage unit; and providing document data mapped to the second embedding vector.

The retrieval word data may include at least one of query type natural language sentence data, keyword data, subject word data, researcher name data, and title data.

The document data may include at least one of thesis data related to the retrieval word data, keyword data related to the retrieval word data, and subject word data related to the retrieval word data.

The plurality of embedding vectors may include embedding vectors related to a plurality of items, respectively output by inputting each of the plurality of items into the first network model.

The plurality of items may include at least one of a specific category among a plurality of categories included in the thesis data, the subject word related to the thesis data, and the keyword allocated to the thesis data.

The subject word may be generated by a second network model performing subject word classification learned by using a learning data set in which the subject word is labeled to learning thesis data.

An embedding vector related to the keyword may be generated based on a common appearing matrix related to a keyword which appears in the learning thesis data at a predetermined number of times or more, and may be acquired by using a third network model in which a loss value is set so that a similarity to an embedding vector of the learning thesis data related to the keyword increases on a space.

The determining of the second embedding vector corresponding to the first embedding vector among the plurality of embedding vectors stored in the storage unit may include generating a plurality of relation scores generated based on a distance between each of the plurality of embedding vectors and the first embedding vector, and determining, as the second embedding vector, an embedding vector having a largest value among the plurality of relation scores.

The determining of the second embedding vector corresponding to the first embedding vector among the plurality of embedding vectors stored in the storage unit may include generating a similarity value between each of the plurality of embedding vectors and the first embedding vector, and determining the second embedding vector based on the similarity value.

The similarity value may have various expressions, which may include a Euclidean distance, a dot product, a cosine similarity, etc.

In an additional exemplary embodiment, the similarity value may be determined based on an equation

$$\frac{A \times B}{\sqrt{{( A )}^{2}} \times \sqrt{{( B )}^{2}}} ,$$

wherein the A may represent any one embedding vector among the plurality of embedding vectors and the B may represent the first embedding vector.

Technical solving means which can be obtained in the present disclosure are not limited to the aforementioned solving means and other unmentioned solving means will be clearly understood by those skilled in the art from the following description.

According to an exemplary embodiment of the present disclosure, target data having high relevance for at least one a natural language sentence, a subject word, and a keyword which are input is retrieved and provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device providing a method for retrieving document data according to some exemplary embodiments of the present disclosure.

FIG. 2 is a diagram for describing an example of a method for retrieving document data according to some exemplary embodiments of the present disclosure.

FIGS. 3 and 4 are diagrams for describing an example of a method for determining a second embedding vector according to some exemplary embodiments of the present disclosure.

FIG. 5 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

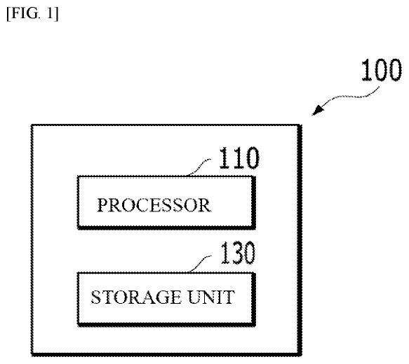

FIG. 1 is a block diagram of a computing device providing a method for retrieving document data according to some exemplary embodiments of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a predetermined type computer system or computer device such as a microprocessor, a main frame computer, a digital processor, a portable device, or a device controller, for example.

The computing device 100 may include a processor 110 and a storage unit 120. However, components described above are not required in implementing the computing device 100, so the computing device 100 may have components more or less than components listed above.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to some exemplary embodiments of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

Meanwhile, throughout this specification, a computation model, the neural network, a network function, and the neural network may be used as an interchangeable meaning. That is, in the present disclosure, the computation model, the (artificial) neural network, the network function, and the neural network may be interchangeably used. Hereinafter, the computation model, the neural network, the network function, and the neural network will be integrated into the neural network, and described.

The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network (DNN) is used, latent structures of the data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The disclosure of the deep neural network described above is just an example and the present disclosure is not limited thereto.

The neural network may be learned in at least one scheme of supervised learning, unsupervised learning, semi supervised learning, or reinforcement learning. The learning of the neural network may be a process of applying knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). A learning rate may be applied differently according to the number of repetition times of the learning cycle of the neural network. For example, in an initial stage of the learning of the neural network, the neural network ensures a certain level of performance quickly by using a high learning rate, thereby increasing efficiency and a low learning rate is used in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to some exemplary embodiments of the present disclosure, the processor 110 may determine a first embedding vector by inputting retrieval word data into a first network model. Here, the retrieval word data may be natural language data input by the user. However, the present disclosure is not limited thereto.

When the first embedding vector is determined, the processor 110 may determine a second embedding vector corresponding to the first embedding vector among a plurality of embedding vectors stored in the storage unit 120. Here, the second embedding vector may be an embedding vector similar to the first embedding vector by a predetermined degree.

Meanwhile, the processor 110 may provide document data mapped to the second embedding vector. Specifically, in the storage unit 120, the document data may be mapped to each of the plurality of embedding vectors. In addition, when the second embedding vector is determined, the processor 110 may extract data mapped to the second embedding vector and provides the extracted document data to the user. That is, the processor 110 may display the document data mapped to the second embedding vector or transmit the corresponding document data to a user terminal.

According to some exemplary embodiments of the present disclosure, the storage unit 120 may store any type of information generated or determined by the processor 110 or any type of information received by the network unit.

The storage unit 120 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the storage unit 120 on the Internet. The description of the storage unit 120 is just an example and the present disclosure is not limited thereto.

According to some exemplary embodiments of the present disclosure, the storage unit 120 may store at least one network model. However, the present disclosure is not limited thereto.

At least one network model may include a first network model that determines the embedding vector by receiving the retrieval word data, a second network model that performs a subject word classification task, and a third network model that generates an embedding vector related to a keyword. However, although not limited thereto, the at least one network model may include network models more or less than the network models.

When the natural language data such as the retrieval word data is input, the first network model may be a network model that determines the embedding vector. Here, the embedding vector output from the first network model may be mapped onto a vector space, and a similarity between the embedding vectors mapped onto the vector space may vary depending on a semantic similarity of the natural language data.

As an example, when first natural language data and second natural language data are natural language data having the semantic similarity, a similarity on the vector space between a first embedding vector acquired by inputting the first natural language data into the first network model and a second embedding vector acquired by inputting the second natural language data into the first network model on the vector space may be high.

As another example, when first natural language data and second natural language data are natural language data having the semantic difference, a similarity on the vector space between a first embedding vector acquired by inputting the first natural language data into the first network model and a second embedding vector acquired by inputting the second natural language data into the first network model on the vector space may be low.

Meanwhile, the first network model may be a pretrained embedding model. Here, in the case of the pretrained sentence embedding model, various types of natural language processing models such as One Hot Encoding, Term Frequency-Inverse Document Frequency(TF-IDF), Latent Semantic Analysis (LSA), Word2Vec, FastText, a Bidirectional Encoder Representations form Transformers (BERT) model, a Generative Pre-trained Transformer (GPT) model, a Text-to-Text Transfer Transformer (T5) model, and a Sentence Bidirectional Encoder Representations form Transformers (SBERT) model may be used as the first network model. However, the present disclosure is not limited thereto.

Meanwhile, the second network model may be a network model learned by using a learning data set in which the subject word is labeled to learning thesis data. Here, the second network model may be a network model that performs a task of classifying the subject word of the input thesis data. However, the present disclosure is not limited thereto.

Specifically, when the thesis data is input, the second network model may determine a class related to the thesis data. Here, the class may be related to the subject word of the thesis data. That is, the storage unit 120 may store a subject word corresponding to each of a plurality of classes, and the processor 110 may determine the subject word based on the class determined in the second network model.

Consequently, the second network model may infer to which subject word the input thesis data is thesis data related.

Meanwhile, when the learning thesis data is input, a third network model may be a network model that outputs an embedding vector related to a keyword. Here, the third network model may be utilized when generating the embedding vector related to the keyword stored in the storage unit.

Specifically, the processor 110 may generate a common appearing matrix related to an appearing keyword such as a predetermined number of times in the learning thesis data. In addition, the processor 110 may generate the embedding vector related to the keyword of the learning thesis data based on the common appearing matrix. In addition, the processor 110 sets a loss value so that a similarity on a space between the embedding vector of the learning thesis data and an embedding vector related to the keyword becomes high to perform learning for the third network model. That is, the processor 110 may generate the embedding vector for the keyword for the learning thesis data by utilizing a graph embedding technique.

Meanwhile, according to some exemplary embodiments of the present disclosure, the embedding vector related to the keyword generated through the third network model may be normalized so as to be placed on a space of the same dimension as the embedding vector of the learning thesis data. However, the present disclosure is not limited thereto.

According to software implementation, embodiments such as a procedure and a function described in the present disclosure may be implemented by separate software modules. Each of the software modules may perform one or more functions and operations described in the specification. A software code may be implemented by a software application written by an appropriate program language. The software code may be stored in the storage unit 120 of the computing device 100 and executed by the processor 110 of the computing device 100.

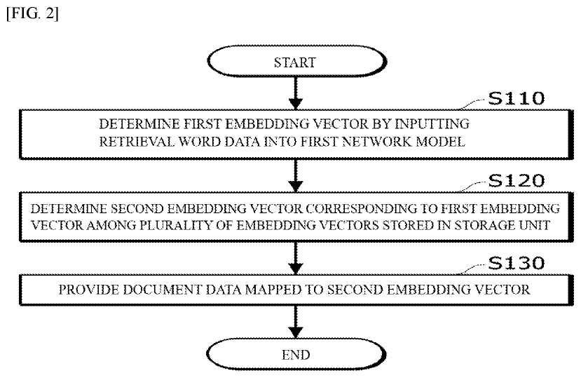

FIG. 2 is a diagram for describing an example of a method for retrieving document data according to some exemplary embodiments of the present disclosure.

Referring to FIG. 2, the processor 110 may determine a first embedding vector by inputting retrieval word data into a first network model (S110).

The retrieval word data may be natural language data which the user inputs to perform retrieval for thesis document data, patent document data, and journal document data included in a public academic information system. However, the present disclosure is not limited thereto.

Specifically, the retrieval word data may include at least one of query type natural language sentence data, keyword data, subject word data, researcher name data, and title data. However, although not limited thereto, the retrieval word data may be constituted by various types of data.

The query type natural language sentence data may be query type natural language sentence data used when retrieving data such as a thesis, etc.

The keyword data may be data related to a word which appears frequently in the thesis. The keyword data may be mapped to each of the thesis data, and retrieval may be performed based on the keyword when performing the retrieval, and as a result, the retrieval word data may also include the keyword data.

The subject word data may be data related to a subject of the thesis. The subject word data may be mapped to each of the thesis data, and retrieval may be performed based on the subject word when performing the retrieval, and as a result, the retrieval word data may also include the subject word data.

The researcher name data may mean data related to a name of a person who writes the thesis. However, although not limited thereto, name data of a person related to the thesis may also be included in the researcher name data. Meanwhile, since the retrieval may also be performed based on the researcher name when performing the retrieval, the researcher name data may also be included in the retrieval word data.

The title data may mean data related to a title of the thesis. Since the retrieval may also be performed based on the thesis title when performing the retrieval, the thesis title data may also be included in the retrieval word data.

When the natural language data is input, the first network model may be a network model that determines the embedding vector. Here, the embedding vector output from the first network model may be mapped onto a vector space, and a similarity between the embedding vectors mapped onto the vector space may vary depending on a semantic similarity of the natural language data.

Meanwhile, the first network model may be a pretrained embedding model. Here, the pretrained sentence embedding model may be configured by using embedding models such as One Hot Encoding, Term Frequency-Inverse Document Frequency (TF-IDF), Latent Semantic Analysis (LSA), Word2Vec, and FastText.

The first network model may also be configured by using the transformer based embedding network model. The transformer means an encoding module that encodes a text, an image, and/or data of various domains based on the attention. When the first network model is configured to include the transformer based embedding network module, the transformer based embedding network module may include, for example, various types of natural language processing models such as a Bidirectional Encoder Representations form Transformers (BERT) model, a Generative Pre-trained Transformer (GPT) model, a Text-to-Text Transfer Transformer (T5) model, and a Sentence Bidirectional Encoder Representations form Transformers (SBERT) model. However, the present disclosure is not limited thereto.

When the transformer model is used as the first network model, the transformer model may be learned by using mass corpus data. The transformer model may calculate an attention between words included in the sentence, and encode the embedding vector based thereon. For example, the attention between the words may encode query, key, and value vectors of each word, acquire an attention score between the encoded query vectors and key vectors of all words in the sentence, and then may be calculated by using the value vectors of the respective words. However, this is one example of calculating the attention in a transformer, and various types of attentions may be utilized.

A method for learning the first network model may be performed through a next sentence prediction (NSP) learning method that guesses whether two random sentences are continuous sentences or discontinuous sentences, and a masked language model (MLM) learning method that masks a random word in the sentence and guesses the masked word. MSP and MLM techniques may be additionally performed in order to fine-tune a pretrained transformer based network module. However, the present disclosure is not limited thereto.

When the first embedding vector is determined in step S110, the processor 110 may determine a second embedding vector corresponding to the first embedding vector among a plurality of embedding vectors stored in the storage unit 120 (S120).

According to some exemplary embodiments of the present disclosure, the plurality of embedding vectors stored in the storage unit 120may include embedding vectors related to a plurality of items output, respectively by inputting the plurality of respective items into the first network model. However, the present disclosure is not limited thereto.

In the present disclosure, the plurality of items may include at least one of a specific category among a plurality of categories included in the thesis data, the subject word related to the thesis data, and the keyword allocated to the thesis data. However, the present disclosure is not limited thereto.

The plurality of categories included in the thesis data may include an abstract category, an appendix category, a summary category, a theoretical background category, a research result category, an introduction category, and a reference literature category. However, the present disclosure is not limited thereto.

The subject word related to the thesis data may mean a subject word allocated to the thesis data. For example, in the case of thesis data related to a specific model of artificial intelligence, a subject word such as the artificial intelligence may be allocated to the corresponding thesis data. However, the present disclosure is not limited thereto.

The keyword allocated to the thesis data may mean a word which appears frequently in the thesis data. For example, when the word such as the artificial intelligence appears frequently in the thesis data, the artificial intelligence may be allocated as the keyword of the corresponding thesis data. However, the present disclosure is not limited thereto.

Meanwhile, according to some exemplary embodiments of the present disclosure, the subject word allocated to the thesis data may be generated by the second network model.

The second network model may be a network model learned by using a learning data set in which the subject word is labeled to the learning thesis data. Here, the second network model may be a network model that performs a task of classifying the subject word of the input thesis data. However, the present disclosure is not limited thereto.

Specifically, when the thesis data is input, the second network model may determine a class related to the thesis data. Here, the class may be related to the subject word of the thesis data. That is, the storage unit 120 may store a subject word corresponding to each of a plurality of classes, and the processor 110 may determine the subject word based on the class determined in the second network model.

Consequently, the second network model may infer to which subject word the input thesis data is thesis data related.

The second network model may be generated by retraining a network model primarily learned by using mass corpus data by using a learning data set in which the subject word is labeled to the thesis data. Here, a value of at least one parameter included in the second network model may be finely tuned in the process of performing retraining.

When the process of performing the retraining is specifically described, the processor 110 may input the learning data set into the second network model, and then calculate an output value. In addition, the processor 110 may calculate a difference between the output value and a value labeled to each learning data set, and update at least one parameter included in the second network model by backpropagation of the difference.

Meanwhile, according to some exemplary embodiments of the present disclosure, the processor 110 may generate a plurality of relation scores generated based on a similarity between each of the plurality of embedding vectors and the first embedding vector. In addition, the processor 110 may determine, as the second embedding vector, an embedding vector having a largest value among the plurality of relation scores. However, the present disclosure is not limited thereto.

According to another some exemplary embodiments of the present disclosure, the processor 110 may determine the second embedding vector based on a value generated by performing an inner product by using each of the plurality of embedding vectors and the first embedding vector. That is, the processor 110 may determine, as the second embedding vector, an embedding vector in which a value generated after the inner product of each of the plurality of embedding vectors and the first embedding vector is largest. However, the present disclosure is not limited thereto.

When the second embedding vector is determined in step S120, the processor 110 may provide document data mapped to the second embedding vector (S130). Here, the document data may include at least one of the thesis data related to the retrieval word data, the keyword data related to the retrieval word data, and the subject word data related to the retrieval word data. However, the present disclosure is not limited thereto.

Meanwhile, according to some exemplary embodiments of the present disclosure, the processor 110 may also provide, to the user, document data related to K upper second embedding vectors having high relevancy with the retrieval word data. In this case, the processor 110 may also provide, to the user, the relation score together with the document data related to K upper second embedding vectors so as for the user to recognize how each document data is related to the retrieval word data. However, the present disclosure is not limited thereto.

When the processor 110 determines the second embedding vector based on any one of the exemplary embodiments, the processor 110 may retrieve and provide data most similar to data which the user intends to retrieve through the retrieval word data. Further, a response may be provided by reflecting relevancy among the keyword, the subject word, and the thesis to the user input.

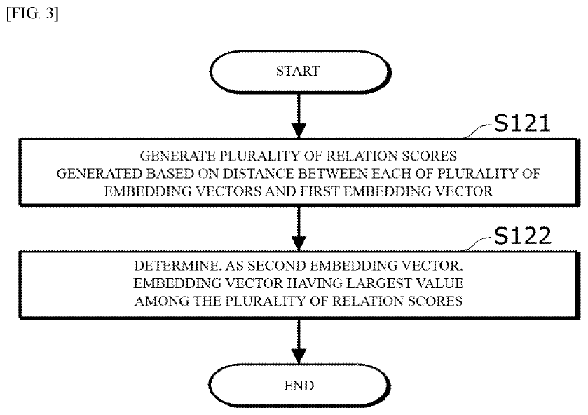

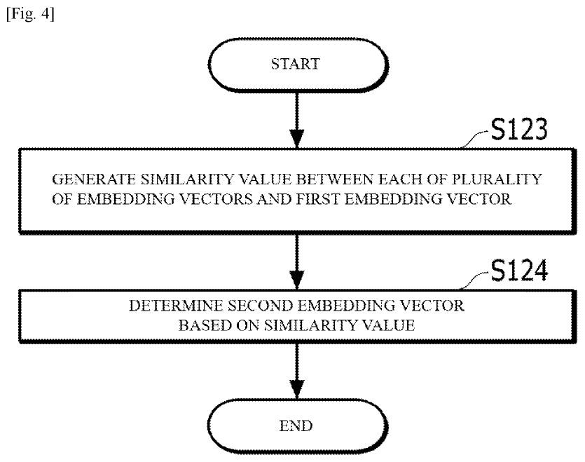

FIGS. 3 and 4 are diagrams for describing an example of a method for determining a second embedding vector according to some exemplary embodiments of the present disclosure.

Referring to FIG. 3, the processor 110 may generate a plurality of relation scores generated based on a similarity between each of the plurality of embedding vectors and the first embedding vector (S121).

Specifically, the processor 110 may embed each of the plurality of embedding vectors and the first embedding vector onto a graph. The processor 110 may calculate the similarity between each of the plurality of embedding vectors and the first embedding vector. In addition, the processor 110 may generate a plurality of relation scores which are in proportion to the similarity between each of the plurality of embedding vectors and the first embedding vector. A relation score of an embedding vector judged to have a high similarity to the first embedding vector may be smaller than a relation score of an embedding vector judged to have a low similarity to the first embedding vector.

When the relation score for each of the plurality of embedding vectors is generated in step S121, the processor 110 may determine, as the second embedding vector, an embedding vector having a largest value among the plurality of relation scores (S122).

That is, according to the present disclosure, the processor 110 may determine, as the second embedding vector, the embedding vector having the largest value of the relation score and provide the determined embedding vector to the user. However, the present disclosure is not limited thereto.

Meanwhile, referring to FIG. 4, the processor 110 may generate a similarity value between each of the plurality of embedding vectors and the first embedding vector (S123). Here, the similarity value may be a value generated based on a similarity in the vector space between directions of each of the plurality of embedding vectors and the first embedding vector.

Specifically, the processor 110 may use a cosine similarity technique when comparing each of the plurality of embedding vectors and the first embedding vector. That is, the processor 110 may use the cosine similarity technique when measuring a similarity between two vectors. Here, the cosine similarity technique may be a technique that acquires an angle between each of the plurality of embedding vectors and the first embedding vector to represent how similar each of the plurality of embedding vectors and the first embedding vector are by a numerical value. The cosine similarity technique may judge that two vectors are similar as vector directions are similar, and when the angle between the vectors is 90 degrees, it may be judged that there is no relevancy and when the angle between the vectors is 180 degrees, it may be judged that two vectors have an opposite relation. However, although not limited thereto, the similarity value may be calculated by using various scales including a Euclidean distance, Jaccrd similarity, a Levenshtein distance, etc.

The similarity value calculated by using the cosine similarity technique may be calculated through Equation 1 below.

$$similarity = cos ( θ ) = \frac{A \times B}{\sqrt{{( A )}^{2}} \times \sqrt{{( B )}^{2}}} \qquad [ Equation 1 ]$$

Here, Similarity may mean the similarity value, θ may mean the angle between two vectors, A may mean any one of embedding vector included in the plurality of embedding vectors, and B may mean the first embedding vector.

According to some exemplary embodiments of the present disclosure, when the processor 110 calculates a similarity value representing the similarity between each of the plurality of embedding vectors and the first embedding vector in step S123, the processor 110 may determine the second embedding vector based on the similarity value (S124).

For example, the processor 110 may determine, as the second embedding vector, an embedding vector which is recognized to have a highest similarity to the first embedding vector among the plurality of embedding vectors, i.e., has a largest similarity value. However, the present disclosure is not limited thereto.

According to some exemplary embodiments of the present disclosure, the computing device 100 may reflect the relevancy among the keyword, the subject word, and the thesis to the retrieval word data input by the user, and sufficiently provide document data corresponding thereto.

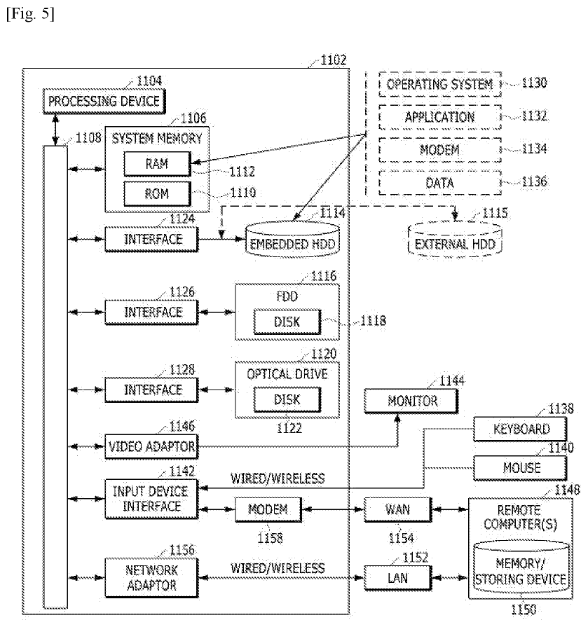

FIG. 5 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the

Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for retrieving document data, which is performed by a computing device including at least one processor, the method comprising:
determining a first embedding vector by inputting retrieval word data into a first network model;
determining a second embedding vector corresponding to the first embedding vector among a plurality of embedding vectors stored in a storage unit; and
providing document data mapped to the second embedding vector.

2. The method of claim 1, wherein the retrieval word data includes at least one of query type natural language sentence data, keyword data, subject word data, researcher name data, or title data.

3. The method of claim 1, wherein the document data includes at least one of thesis data related to the retrieval word data, keyword data related to the retrieval word data, or subject word data related to the retrieval word data.

4. The method of claim 1, wherein the plurality of embedding vectors includes embedding vectors related to a plurality of items, respectively output by inputting each of the plurality of items into the first network model.

5. The method of claim 4, wherein the plurality of items includes at least one of a specific category among a plurality of categories included in the thesis data, the subject word related to the thesis data, or the keyword allocated to the thesis data.

6. The method of claim 5, wherein the subject word is generated by a second network model performing subject word classification learned by using a learning data set in which the subject word is labeled to learning thesis data.

7. The method of claim 5, wherein an embedding vector related to the keyword is generated based on a common appearing matrix related to a keyword which appears in the learning thesis data at a predetermined number of times or more, and is acquired by using a third network model in which a loss value is set so that a similarity to an embedding vector of the learning thesis data related to the keyword increases on a space.

8. The method of claim 1, wherein the determining of the second embedding vector corresponding to the first embedding vector among the plurality of embedding vectors stored in the storage unit includes
generating a plurality of relation scores generated based on a similarity between each of the plurality of embedding vectors and the first embedding vector, and
determining, as the second embedding vector, an embedding vector having a largest value among the plurality of relation scores.

9. The method of claim 1, wherein the determining of the second embedding vector corresponding to the first embedding vector among the plurality of embedding vectors stored in the storage unit includes
generating a similarity value between each of the plurality of embedding vectors and the first embedding vector, and
determining the second embedding vector based on the similarity value.

10. The method of claim 9, wherein the similarity value is enabled to be expressed by using at least one of a cosine similarity, an inner product of two vectors, or an Euclidean distance.

11. The method of claim 9, wherein the similarity value is determined based on an equation
$$\frac{A \times B}{\sqrt{\text{?}} \times \sqrt{\text{?}}} ,$$
$$\text{?} \text{indicates text missing or illegible when filed}$$
wherein the A represents any one embedding vector among the plurality of embedding vectors and the B represents the first embedding vector.

12. A computing device providing a document data retrieval result, the computing device comprising:
a storage unit storing a first network model; and
a processor,
wherein the processor
determines a first embedding vector by inputting retrieval word data into the first network model,
determines a second embedding vector corresponding to the first embedding vector among a plurality of embedding vectors stored in a storage unit, and
provides document data mapped to the second embedding vector.

13. A non-transitory computer readable medium storing a computer program, wherein the computer program comprises instructions for causing one or more processors of a computing device to perform the following steps for retrieving document data, the steps comprising:
determining a first embedding vector by inputting retrieval word data into a first network model;
determining a second embedding vector corresponding to the first embedding vector among a plurality of embedding vectors stored in a storage unit; and
providing document data mapped to the second embedding vector.
